(19) United States
(12) Patent Application Publication
(10) Pub. No.: US 2005/0201410 A1
(43) Pub. Date: Sep. 15, 2005

(54) Subscriber unit redundant system and subscriber unit redundant method

(75) Inventors: Minoru Sekine, Tokyo (JP); Masashi Tanaka, Tokyo (JP)

Correspondence Address: FOLEY AND LARDNER;SUITE 500, 3000 K STREET NW, WASHINGTON, DC, 20007, US

(73) Assignee: NEC CORPORATION

(21) Appl. No.: 11/063,541

(22) Filed: Feb. 24, 2005

(30) Foreign Application Priority Data
Feb. 26, 2004 (JP) 2004-51746

(51) Int. Cl. H04L 12/50

(52) U.S. Cl. 370/463

(57) ABSTRACT

With respect to first to 11th DSL subscriber line termination units (112-1 to 112-11) each terminating subscriber lines for a plurality of channels on a board, there is provided an auxiliary DSL subscriber line termination unit (112-12) terminating the same number of subscriber lines on a board. Upon occurrence of failure corresponding to any of the channels, a redundant control panel (114) implements switching to a corresponding channel of the auxiliary DSL subscriber line termination unit. By this switching, a physical interface number of a packet is changed. However, it can be dealt with by conversion to the same logical interface number as before using a mapping table (212) under the control of a protection control section (215).

### BACKGROUND OF THE INVENTION

This invention relates to a subscriber unit redundant system and a subscriber unit redundant method that implement a remedy when failure occurs at a portion of a subscriber unit terminating a plurality of subscriber lines and, in particular, relates to a subscriber unit redundant system and a subscriber unit redundant method that can be suitably used in an asymmetric digital subscriber transmission system.

Following the spread of always-on connection to the Internet, attention has been paid to the technology using ADSL (Asymmetric Digital Subscriber Line) that enables reception of a relatively large amount of data at low communication charge by the use of an existing telephone line.

FIG. 1 shows an outline of a communication system using the ADSL. In FIG. 1, ADSL modems 501-1 to 501-M are respectively disposed at subscribers' homes (not-illustrated) and respectively connected to Internet connection devices (not-illustrated) such as computers and Internet televisions. The ADSL modems 501-1 to 501-M are respectively connected to a subscriber exchange 502 via user splitters (not-illustrated). In the subscriber exchange 502, splitter units 511-1 to 511-M are provided in one-to-one correspondence with the ADSL modems 501-1 to 501-M. The subscriber exchange 502 further comprises DSL subscriber line termination units (hereinafter referred to as “LTUs”) 514-1 to 514-3.

Among the splitter units 511-1 to 511-M, the splitter unit 511-1 will be representatively described. The splitter unit 511-1 splits a signal 504-1 received via a DSL subscriber line 503-1 into a telephone signal 512-1 of a voice frequency band and an ADSL signal 513-1 of a predetermined frequency band higher than the voice frequency band. The telephone signal 512-1 is sent to an exchange 515 serving for line switching. The ADSL signal 513-1 split by the splitter unit 511-1 is modulated/demodulated at an initial stage (not illustrated) of the corresponding LTU 514-1 so that ATM cells are extracted and then input into an integrated gateway unit (IGU) 517 via a backplane bus 516. Details of the integrated gateway unit 517 will be described later. Like the splitter unit 511-1, the splitter units 511-2 to 511-M respectively split signals 504-2 to 504-M received via DSL subscriber lines 503-2 to 503-M into telephone signals of the voice frequency band and ADSL signals 513-2 to 513-L.

Each of the LTUs 514-1 to 514-3 comprises a DSL transceiver module corresponding to a predetermined number of lines (e.g. 32 lines at maximum). The DSL transceiver module is formed by, for example, a DSP (Digital Signal Processor). Each of the LTUs 514-1 to 514-J performs high-speed data communication in an uplink direction via an uplink line 521 serving as an interface for connection to the Internet 519, by the use of the corresponding lines among the DSL subscriber lines 503-1 to 503-M, while receives and modulates downlink data and sends the modulated downlink data to the corresponding lines among the DSL subscriber lines 503-1 to 503-M. Note that the uplink direction is a direction toward the Internet 519, while a downlink direction is opposite to the uplink direction.

In the communication system as described above, following the spread of the ADSL modems 501-1 to 501-M, the number of the LTUs 514-1 to 514-J each connecting, for example, 32 lines also increases. Therefore, in order to improve the reliability of the whole subscriber exchange 502, a countermeasure upon occurrence of failure in any of the LTUs 514-1 to 514-J is important.

FIG. 2 shows the main part of a subscriber unit redundant system generally employed for such a failure countermeasure. The integrated gateway unit 517 comprises a bridge 531 for entering only necessary packets from a network 523. To the integrated gateway unit 517 are connected current-use DSL subscriber line termination units (hereinafter referred to as “current-use LTUs”) 532-1 to 532-J respectively corresponding to the LTUs 514-1 to 514-J shown in FIG. 1 and, in addition thereto, auxiliary DSL subscriber line termination units (hereinafter referred to as “auxiliary LTUS”) 533-1 to 533-J in one-to-one correspondence with the current-use LTUs 532-1 to 532-J. First change-over switches 534-1 to 534-J are respectively disposed adjacent to the current-use LTUs 532-1 to 532-J and the auxiliary LTUs 533-1 to 533-J on their sides closer to the bridge 531. As illustrated, the first change-over switches 534-1 to 534-J respectively have contacts that are normally connected to the current-use LTUs 532-1 to 532-J. On the other hand, second change-over switches 535-1 to 535-J are respectively disposed adjacent to the current-use LTUs 532-1 to 532-J and the auxiliary LTUs 533-1 to 533-J on their sides closer to the ADSL modems 501-1 to 501-M (FIG. 1). As illustrated, the second change-over switches 535-1 to 535-J respectively have contacts that are normally connected to the current-use LTUS 532-1 to 532-J.

In the subscriber unit redundant system shown in FIG. 2, the current-use LTUs 532-1 to 532-J are normally connected to the bridge 531 and packets are exchanged therebetween. Upon occurrence of failure or trouble (hereinafter referred to as simply “failure”) in any of the current-use LTUs 532-1 to 532-J, corresponding ones of the first and second change-over switches 534-1 to 534-J and 535-1 to 535-J are automatically or manually switched from current-use to auxiliary. For example, upon occurrence of failure in the current-use LTU 532-1, the auxiliary LTU 533-1, instead of the current-use LTU 532-1, exchanges packets between itself and the bridge 531. Accordingly, for example, the signal processing of corresponding 32 lines of the current-use LTU 532-1 is restored so that services to subscribers can be continued.

However, as already explained above, following the spread of the communication system using the asymmetric digital subscriber lines, the number of the DSL subscriber line termination units in use has been rapidly increasing. The subscriber unit redundant system shown in FIG. 2 raises a problem of requiring a device in which the number of the DSL subscriber line termination units is substantially doubled. In terms of this problem, the following subscriber unit redundant system is proposed in JP-A-2003-061118. In this subscriber unit redundant system, with respect to a plurality of DSL subscriber line termination units, only one DSL subscriber line termination unit is excessively disposed as an additional DSL subscriber line termination unit. Further, there is provided a common connection board that can connect each of the DSL subscriber line termination units to the additional DSL subscriber line termination unit. Upon occurrence of failure in any of the DSL subscriber line termination units, switching to the additional DSL subscriber line termination unit is carried out by controlling the common connection board.

In the subscriber unit redundant system according to the foregoing proposal, each of the DSL subscriber line termination units is provided with a detection section for detecting failure and a relay circuit. Upon detection of failure by the detection section, the relay circuit connects a port corresponding to the DSL subscriber line termination unit subjected to the failure, to the common connection board. Further, by this switching of the relay circuit, a relay circuit provided for the additional DSL subscriber line termination unit is driven to connect the additional DSL subscriber line termination unit to the common connection board by the use of a common line. As a result, the DSL subscriber line termination unit subjected to the failure is switched to the additional DSL subscriber line termination unit.

However, in the subscriber unit redundant system using the additional DSL subscriber line termination unit, the switching upon occurrence of failure is implemented in unit of the whole DSL subscriber line termination unit. Therefore, when a system is configured such that each of the DSL subscriber line termination units terminates a plurality of DSL subscriber lines and a processing circuit is provided per line or channel, switching to the additional DSL subscriber line termination unit becomes necessary even upon occurrence of failure only in part of the processing circuits. Accordingly, there is a problem that those processing circuits not subjected to the failure in the DSL subscriber line termination unit subjected to the failure cannot be effectively utilized.

### SUMMARY OF THE INVENTION

It is therefore an object of this invention to provide a subscriber unit redundant system and a subscriber unit redundant method that can realize a redundant configuration wherein even upon occurrence of failure in any of a plurality of subscriber line termination units each having the same processing circuits for a plurality of channels, only the processing circuit/circuits of the channel/channels subjected to the occurrence of the failure is/are switched to corresponding auxiliary one/ones.

A subscriber unit redundant system according to an aspect of this invention comprises a predetermined number of current-use subscriber units each provided on a board with processing circuits of the same structure for a plurality of channels and each corresponding to as many subscriber lines as the number of said plurality of channels, and an auxiliary subscriber unit provided on a board with processing circuits for the plurality of channels. Each of the processing circuits has the same structure as the processing circuit of the current-use subscriber unit. The subscriber unit redundant system further comprises a per-channel switching circuit that, upon occurrence of failure in any of the processing circuits in the predetermined number of current-use subscriber units, switches a path connecting between the subscriber line and the processing circuit which both correspond to the channel subjected to the occurrence of the failure, to a path connected to the processing circuit of the same channel in the auxiliary subscriber unit.

According to another aspect of this invention a subscriber unit redundant method is provided. The subscriber unit redundant method comprises the step of providing a predetermined number of current-use subscriber units and an auxiliary subscriber unit. Each of the current-use subscriber units and the auxiliary subscriber unit has the same number of processing circuits provided in one-to-one correspondence with a plurality of subscriber lines. The processing circuits serve as per-channel processing circuits. The subscriber unit redundant method further comprises the step of, upon occurrence of failure in any of the processing circuits in the predetermined number of current-use subscriber units, switching a path connecting between the subscriber line and the processing circuit which both correspond to a channel subjected to the occurrence of the failure, to a path connected to the processing circuit of the same channel in the auxiliary subscriber unit.

With this configuration, upon the occurrence of the failure, the processing circuit per channel can be switched to the processing circuit of the corresponding channel of the auxiliary subscriber unit. Therefore, even if the processing circuits of all the channels forming one current-use subscriber unit are subjected to failure at a time, the auxiliary subscriber unit can be substituted for those processing circuits so that it is possible to configure the highly reliable subscriber unit redundant system.

### BRIEF DESCRIPTION OF THE DRAWINGS

FIG. 1 is a system configuration diagram showing an outline of a conventional communication system using ADSL;

FIG. 2 is a block diagram showing the main part of a subscriber unit redundant system generally employed for a failure countermeasure;

FIG. 3 is a system configuration diagram showing an outline of a communication system using a subscriber unit redundant system according to a preferred embodiment of this invention;

FIG. 4 is an explanatory diagram showing the main part of the subscriber unit redundant system shown in FIG. 3;

FIG. 5 is a block diagram showing a system configuration of the main part of a subscriber line accommodation device in the embodiment of this invention;

FIG. 6 is a block diagram showing an outline of a hardware configuration of an integrated gateway unit in the embodiment of this invention;

FIG. 7 is a block diagram showing an outline of a software configuration of the integrated gateway unit in the embodiment of this invention;

FIG. 8 is a principle diagram showing a circuit for performing interface conversion and its peripheral configuration in the embodiment of this invention;

FIG. 9 is an explanatory diagram showing part of a mapping table before rewriting in the embodiment of this invention;

FIG. 10 is an explanatory diagram showing part of the mapping table after rewriting in the embodiment of this invention; and

FIG. 11 is a flowchart showing an outline of processing of a device control section of this invention upon occurrence of failure.

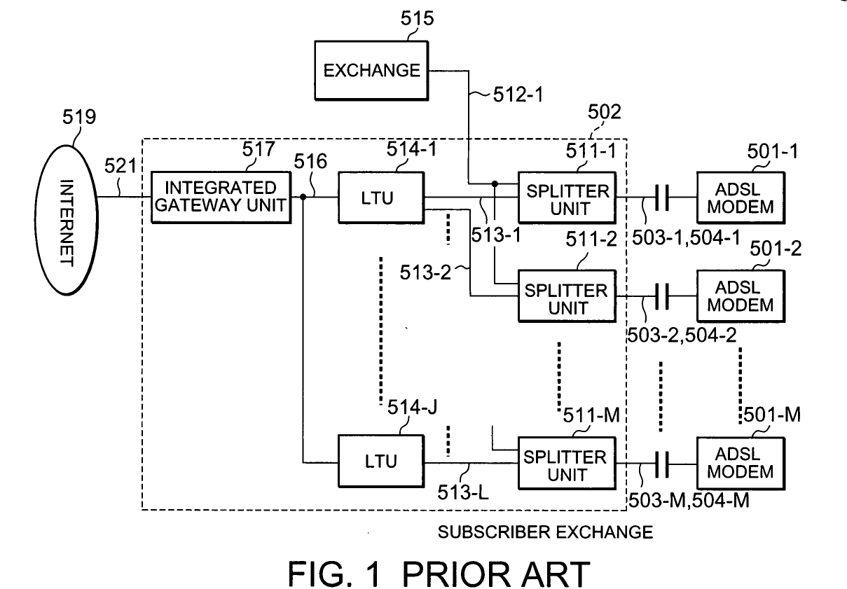

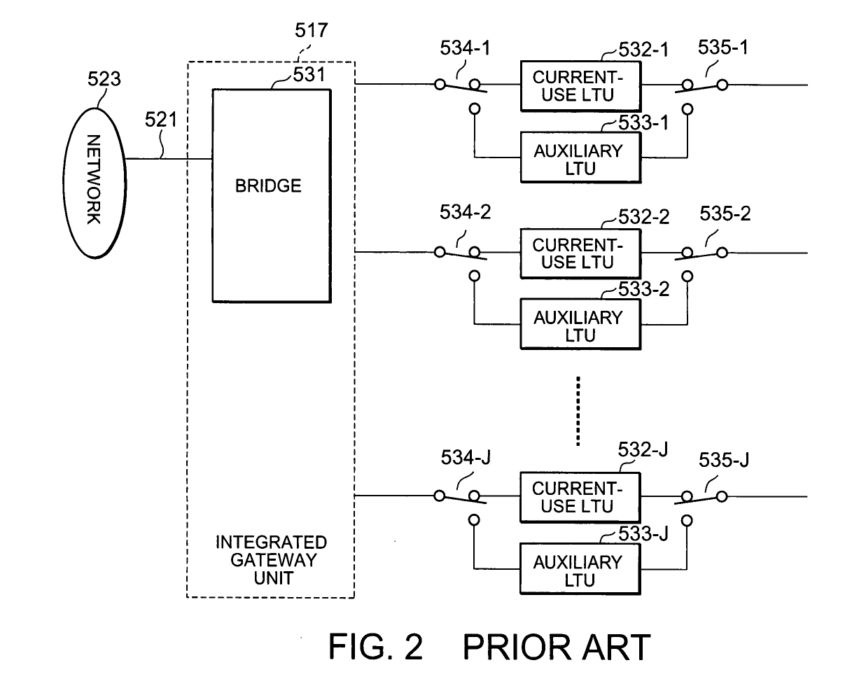

### DESCRIPTION OF THE PREFERRED EMBODIMENT OF THE INVENTION

Now, a preferred embodiment of this invention will be described in detail.

<Outline of System>

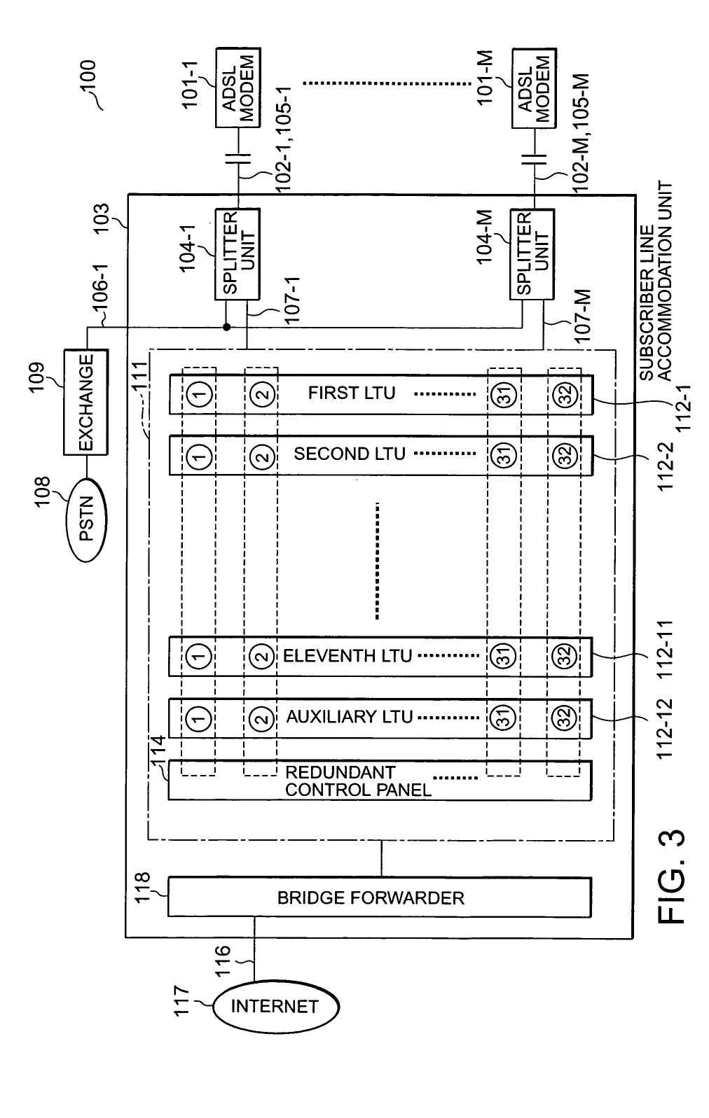

FIG. 3 shows an outline of a communication system 100 using a subscriber unit redundant system according to the embodiment of this invention. The communication system 100 includes a subscriber line accommodation device 103 and uses ADSL (Asymmetric Digital Subscriber Line). In the communication system 100, ADSL modems 101-1 to 101-M respectively connected to communication devices (not illustrated) such as computers and internet televisions are each disposed at a corresponding one of subscribers' homes. The subscriber line accommodation device 103 includes splitter units 104-1 to 104-M. The ADSL modems 101-1 to 101-M are connected to each of the splitter units 104-1 to 104-M via DSL subscriber lines 102-1 to 102-M. Signals 105-1 to 105-M are respectively sent via the DSL subscriber lines 102-1 to 102-M. Hereinbelow, a description will be mainly given of the splitter unit 104-1 among the splitter units 104-1 to 104-M,

The splitter unit 104-1 splits the signal 105-1 received via the DSL subscriber line 102-1 into a telephone signal 106-1 of a voice frequency band and an ADSL signal 107-1 of a predetermined frequency band higher than the voice frequency band. The telephone signal 106-1 is sent to an exchange 109 serving for line switching and connected to a PSTN (Public Switched Telephone Network) 108.

The ADSL signals 107-1 to 107-M split by the splitter units 104-1 to 104-M are output into an accommodation rack 111 provided in the subscriber line accommodation device 103. In the accommodation rack 111, first to 11th DSL subscriber line termination units (current-use subscriber units; hereinafter referred to as “LTUs”) 112-1 to 112-11 are detachably disposed in order of first to 11th slots. Each of the first to 11th LTUs 112-1 to 112-11 comprises a DSL transceiver module corresponding to 32 lines at maximum. In the accommodation rack 111, a twelfth DSL subscriber line termination unit is also detachably mounted in a twelfth slot as an auxiliary DSL subscriber line termination unit (auxiliary subscriber unit; hereinafter referred to as “auxiliary LTU”) 112-12. Further, in the accommodation rack 111, a redundant control panel 114 that executes a redundant control with respect to the first to 11th LTUs 112-1 to 112-11 is detachably mounted in a thirteenth slot.

The auxiliary LTU 112-12 has a circuit configuration identical to that of each of the first to 11th LTUs 112-1 to 112-11. Therefore, when it is not necessary to construct a system of redundant configuration using the auxiliary LTU 112-12, the auxiliary LTU 112-12 can be used as a twelfth DSL subscriber line termination unit. If the first to 12th LTUs 112-1 to 112-12 are used without employing the redundant configuration as referred to above, 384 DSL subscriber lines 102-1 to 102-384 at maximum can be accommodated in the subscriber line accommodation device 103. Naturally, if the accommodation rack 111 can be expanded, the number of DSL subscriber lines 102 to be accommodated can also be increased.

A bridge forwarder 118 connected to the internet 117 via an uplink line 116 is connected to the accommodation rack 111 via a nonillustrated circuit. Naturally, it may be configured that the bridge forwarder 118 is also detachably inserted into the accommodation rack 111. The bridge forwarder 118 has a function of forwarding at Layer 2 and classifying packets based on MAC (Media Access Control) addresses.

Referring to FIG. 3, a principle of the subscriber unit redundant system in this embodiment will be briefy explained. Each of the first to 11th LTUs 112-1 to 112-11 comprises DSL transceiver modules (not illustrated) corresponding to 32 lines, i.e. first to 32nd lines as indicated by encircled numerals in FIG. 3. In the case where “M” is “352”, the first to 11th LTUS 112-1 to 112-11 use the DSL subscriber lines 102-1 to 102-352 to perform high-speed data communication in an uplink direction via the uplink line 116 serving as an interface for connection to the internet 117, while receive and modulate downlink data and send the modulated downlink data to the DSL subscriber lines 102-1 to 102-352. Note that the uplink direction is a direction toward the internet 117.

In this embodiment employing the redundant configuration, the DSL transceiver modules of the same channel number in the first to 11th LTUs 112-1 to 112-11 correspond to a DSL transceiver module of the same channel number in the auxiliary LTU 112-12. Then, upon occurrence of failure in any of the DSL transceiver modules in the first to 11th LTUs 112-1 to 112-11, the DSL transceiver module in the auxiliary LTU 112-12 having the same channel number as that of the DSL transceiver module subjected to the failure operates instead of it under the control of the redundant control panel 114.

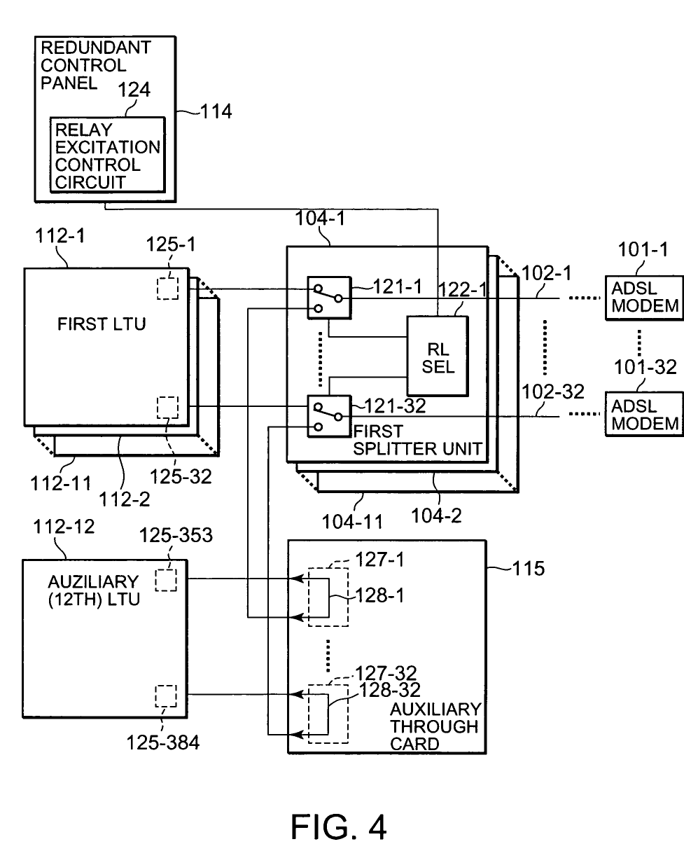

FIG. 4 shows the main part of the subscriber unit redundant system in this embodiment. The first to 11th LTUs 112-1 to 112-11 are respectively connected to first to 11th splitter units 104-1 to 104-11 and further connected to the redundant control panel 114. On the other hand, the auxiliary LTU 112-12 is connected to an auxiliary through card 115. The auxiliary through card 115 is connected to the first to 11th LTUs 112-1 to 112-11 and performs route setting by switching a circuit portion, subjected to failure in the first to 11th LTUs 112-1 to 112-11, to a substitute circuit portion in the auxiliary through card 115 upon occurrence of the failure.

The first splitter unit 104-1 comprises first to 32nd change-over switches 121-1 to 121-32 for connection to the first to 32nd ADSL modems 101-1 to 101-32 via the first to 32nd DSL subscriber lines 102-1 to 102-32, respectively. The first splitter unit 104-1 further comprises a first relay contact selection circuit (RLSEL) 122-1 for switching a contact of each of the change-over switches 121-1 to 121-32 corresponding to a circuit portion of the first LTU 112-1 subjected to failure. The 2nd to 11th splitter units 104-2 to 104-11 connected to the 2nd to 11th LTUs 112-2 to 112-11 each have the same circuit configuration.

The redundant control panel 114 comprises a relay excitation control circuit 124 that individually controls the relay contact selection circuits 122-1 to 122-11 of the first to 11th splitter units 104-1 to 104-11 (only the relay contact selection circuit 122-1 of the first splitter unit 104-1 is illustrated). For example, it is assumed that a first DSL transceiver module 125-1 corresponding to the first DSL subscriber line 102-1 in the first LTU 112-1 is subjected to occurrence of failure and an exchange thereof becomes necessary. In this case, the relay excitation control circuit 124 in the redundant control panel 114 sends a signal to the corresponding first relay contact selection circuit 122-1 of the first splitter unit 104-1 to thereby control the first relay contact selection circuit 122-1 to switch a contact of the corresponding first change-over switch 121-1 to its normally-open contact side.

In the first to 32nd change-over switches 121-1 to 121-32, normally-closed contact sides thereof in the illustrated contact state are respectively connected to the first to 32nd DSL transceiver modules 125-1 to 125-32 in the first LTU 112-1. On the other hand, normally-open contact sides of the first to 32nd change-over switches 121-1 to 121-32 are respectively connected to input-side terminals of first to 32nd jumper circuits 127-1 to 127-32 of the auxiliary through card 115. Output-side terminals of the first to 32nd jumper circuits 127-1 to 127-32 are respectively connected to 353th to 384th DSL transceiver modules 125-353 to 125-384 disposed in the auxiliary LTU 112-12. The input-side terminals and the output-side terminals of the first to 32nd jumper circuits 127-1 to 127-32 are shorted therebetween in corresponding pairs thereof by physical or electronic jumper lines 128-1 to 128-32 when the auxiliary LTU 112-12 being also the twelfth LTU is set to “auxiliary”.

FIG. 4 specifically shows only the circuit portions of the first LTU 112-1 and the first splitter unit 104-1 associated therewith. Also with respect to 33rd to 352nd change-over switches 121-33 to 121-352 (not illustrated) disposed in the 2nd to 11th splitter units 104-2 to 104-11, the change-over switches 121 in each splitter unit 104 corresponding to the 32 channels identified by the encircled numerals in FIG. 3 are commonly connected to the corresponding input-side terminals of the first to 32nd jumper circuits 127-1 to 127-32. To given an example, the 33rd, 65th, 97th, . . . change-over switches 121-33, 121-65, 121-97, . . . correspond to the channels of the DSL transceiver modules 125 identified by the encircled numeral of “1” in FIG. 3 and therefore are commonly connected to the input-side terminal of the first jumper circuit 127-1 of the auxiliary through card 115.

As a result, upon occurrence of the failure in the first DSL transceiver module 125-1 corresponding to the first DSL subscriber line 102-1 in the first LTU 112-1, the first change-over switch 121-1 is switched to its normally-open contact side as described before. Accordingly, the 353rd DSL transceiver module 125-353 of the auxiliary LTU 112-12 operates instead of the first DSL transceiver module 125-1. Likewise, upon occurrence of the failure in the 32nd DSL transceiver module 125-32 corresponding to the 32nd DSL subscriber line 102-32 in the first LTU 112-1, the 32nd change-over switch 121-32 is switched to its normally-open contact side. Accordingly, the 384th DSL transceiver module 125-384 of the auxiliary LTU 112-12 operates instead of the 32nd DSL transceiver module 125-32.

In FIG. 4, the splitter units 104-1 to 104-M, the redundant control panel 114, and the auxiliary through card 115 collectively serve as a per-channel switching circuit claimed in claim 1. In particular, the redundant control panel 114 serves as a switching control section claimed in claim 5.

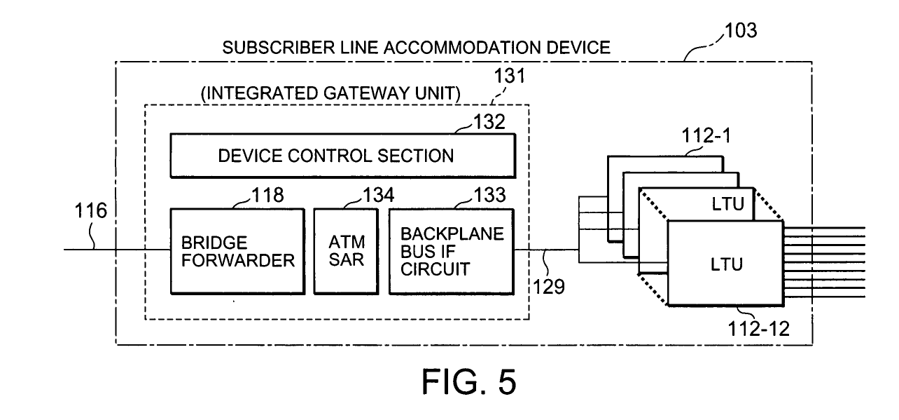

FIG. 5 shows a system configuration of the main part of the subscriber line accommodation device 103. The subscriber line accommodation device 103 comprises the LTUs 112-1 to 112-12 described referring to FIG. 4, which are connected to one end side of an integrated gateway unit 131 via a backplane bus 129. The integrated gateway unit 131 has an interface function for connection to the internet and is connected, at its other end side, to the uplink line 116.

The integrated gateway unit 131 comprises a device control section 132 that performs the whole control and monitoring of the subscriber line accommodation device 103, and a backplane bus IF (Interface) circuit 133 serving as an interface for a backplane. The integrated gateway unit 131 further comprises an ATM SAR (Asynchronous Transfer Mode Segmentation and Reassembly) 134 that carries out segmentation and reassembly of ATM cells, and the bridge forwarder 118 that performs forwarding of Layer 2 frames and classifies packets based on MAC addresses. The ATM cells are transmitted between the ATM SAR 134 and the LTUs 112-1 to 112-12, while Ethernet (registered trademark) frames are transmitted at input and output portions of the uplink line 116.

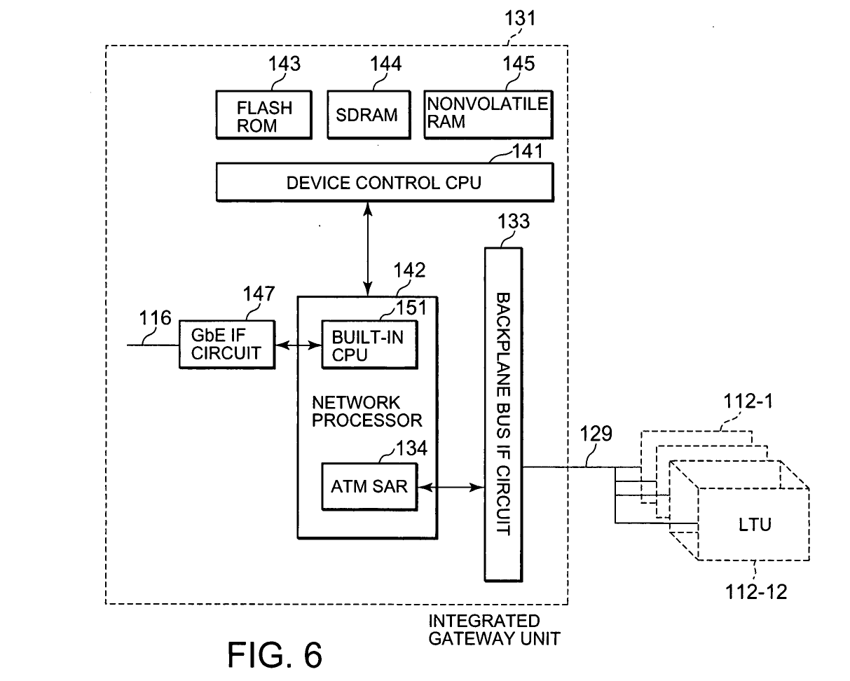

FIG. 6 shows an outline of a circuit configuration of the integrated gateway unit 131. The integrated gateway unit 131 comprises two processors, i.e. a device control CPU (Central Processing Unit) 14 and a network processor 142, and a memory group having a flash ROM (Read Only Memory) 143, an SDRAM (Synchronous Dynamic Random Access Memory) 144, and a nonvolatile RAM (Random Access Memory) 145. The integrated gateway unit 131 further comprises the backplane bus IF circuit 133 formed by an ASIC (Application Specific Integrated Circuit) as a dedicated integrated circuit, and a GbE (Gigabit Ethernet (registered trademark)) IF (Interface) circuit 147 formed by an LSI (Large Scale Integration) chip (not illustrated).

The device control CPU 141 executes a control with respect to management, communication, and setting of configuration of the device. The network processor 142 is a high-speed communication processor comprising a built-in CPU 151 and the ATM SAR 134. The bridge forwarder 118 shown in FIG. 5 is created in a software manner by the use of the network processor 142 and carries out processing such as reception of frames, discrimination of destinations, and forwarding to the destinations. The backplane bus IF circuit 133 is created by hardware and executes various controls about the lines such as a control of buses with respect to the lines for carrying out high-speed processing of frames transmitted at gigabit speed. The backplane bus IF circuit 133 processes the LTUs 112-1 to 112-12 individually by polling.

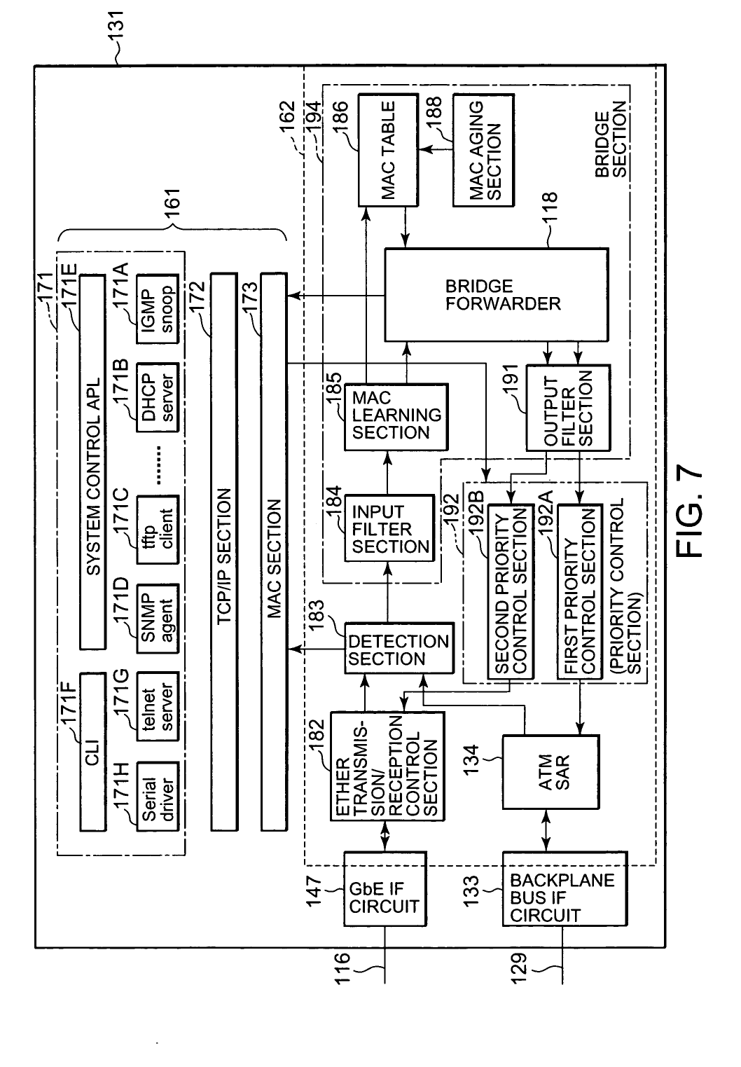

FIG. 7 shows main functional blocks of the integrated gateway unit 131. The integrated gateway unit 131 comprises a basic functional section 161 created by the device control CPU 141 and its associated hardware in FIG. 6, and a signal processing section 162. The signal processing section 162 is created in a software manner by the use of the network processor 142 and its associated hardware in FIG. 6 and a control program. Naturally, the signal processing section 162 may also be created only by hardware.

In this embodiment, the basic functional section 161 comprises a functional software section 171 that performs processing such as communicating with a host (not illustrated) to operate a console (not illustrated), a TCP/IP (Transmission Control Protocol/Internet Protocol) section 172 as a protocol for performing packet communication with the functional software section 171, and an MAC section 173 that manages an MAC (Media Access Control).

In this embodiment, the functional software section 171 includes an IGMP (Internet Group Management Protocol) snoop section 171A that snoops multicast communication, and a DHCP (Dynamic Host Configuration Protocol) server 171B that automatically performs dynamic allocation of IP (Internet Protocol) addresses reusable in an IP network and various setting. The functional software section 171 further includes a tftp (trivial file transfer protocol) client 171C, an SNMP (Simple Network Management Protocol) agent 171D for device monitoring, and a system control application (APL) 171E. The functional software section 171 further includes a CLI (Command Line Interface) section 171F, a virtual terminal protocol (TELNET) server 171G, and a serial driver 171H. Among these components, a detailed description will be given later of the components that are particularly necessary for describing this invention.

The signal processing section 162 comprises an Ether transmission/reception control section 182 that performs transmission and reception of frames on the Ethernet (registered trademark) between itself and the GbE IF circuit 147. Packets received from, for example, a program distribution server (not illustrated) via the uplink line 116 shown in FIG. 5 and the Ether transmission/reception control section 182 and packets received from the LTUs 112-1 to 112-12 via the backplane bus IF circuit 133 and the ATM SAR 134 in FIG. 6 are sent to a detection section 183 where a forwarding destination of each packet is sorted into the MAC section 173 or an input filter section 184. A packet carrying an IGMP control message, an IP packet carrying a DHCP protocol message, and an IP packet directed to an IP address of the basic functional section 161 are forwarded to the MAC section 173.

The input filter section 184 serves to block, for example, an illegally accessed Layer 2 frame or Layer 3 packet. The input filter section 184 compares a forwarded packet with a condition registered in advance and discards an agreed packet or passes only an agreed packet. The packet having passed through the input filter section 184 is delivered to an MAC learning section 185. The MAC learning section 185 learns sender MAC addresses of respective received packets and logical port numbers having received the packets and registers these results in an MAC table 186. Then, the packet is delivered to the bridge forwarder 118. The bridge forwarder 118 extracts a destination MAC address from the packet and searches the MAC table 186 to retrieve which of logical ports is connected to the extracted destination MAC address. Even if a transfer destination of a packet to be relayed cannot be found at the beginning to thereby send the packet to all logical ports other than a logical port having received the packet, it becomes possible through such learning of transfer destinations to transfer the packet only to the logical port corresponding to its destination by the use of sender information as a key.

An MAC aging section 188 is connected to the MAC table 186. Even in case of an MAC address stored in the MAC table 186 as a result of the learning, unless the same address is relearned within a preset time, the MAC aging section 188 deletes it from the MAC table 186 as determining that an effective time is over.

The bridge forwarder 118 formed as a Layer 2 forwarder is connected to the MAC learning section 185, the MAC table 186, an output filter section 191, and the MAC section 173. The output filter section 191 corresponds to the input filter section 184. After identifying an output logical port corresponding to a destination, the output filter section 191 discards an inappropriate packet without sending it out in the process of controlling discarding or passing of a frame matching a filtering condition set for the identified output logical port. The conditions used by the output filter section 191 for such filtering are preset by a network manager according to protocols, IP addresses, and input/output logical ports.

On the output side of the output filter section 191 is disposed a priority control section 192 comprising a first priority control section 192A and a second priority control section 192B. The priority control section 192 executes a control of forwarding a particular packet carrying voice or the like which requires real-time transmission, preferentially to other packets. For this control, there exist a priority control that gives priority to a protocol and a priority control that gives priority to an address of a particular destination. A frame heading toward the LTUs 112-1 to 112-12 (FIG. 4) via the first priority control section 192A is forwarded to the ATM SAR 134. The ATM SAR 134 converts the frame on the Ethernet (registered trademark) into ATM cells and sends them to the LTUs 112-1 to 112-12 via the backplane bus IF circuit 133. On the other hand, a frame heading toward the uplink line 116 (FIG. 4) via the second priority control section 192B is forwarded to the Ether transmission/reception control section 182. The frame input into the Ether transmission/reception control section 182 is input into the GbE IF circuit 147 as it is, i.e. in the form of the frame.

<Processing of Integrated Gateway Unit in Reception>

As described with reference to FIG. 4, upon occurrence of failure in part of the circuits within the first to 11th LTUs 112-1 to 112-11, a corresponding one of the DSL transceiver modules 125-353 to 125-384 of the auxiliary LTU 112-12 is substituted therefor on a channel basis, i.e. in unit of the channel as identified by each of the encircled numbers from “1” to “32”. However, if only this control is simply performed, a physical interface number of the DSL subscriber line termination unit after the substitution is changed. In the example as described above, since the failure has occurred at the first (first channel) circuit portion, i.e. the first DSL transceiver module 125-1, in the first LTU 112-1, if a physical interface number thereof is given as “1/1” (slot number/channel number), this will be changed to “12/1”.

The backplane bus 129 shown in FIGS. 5 and 6 delivers a signal to the bridge forwarder 118 (FIG. 5) according to a physical interface number thereof. Therefore, if a signal coming from the switched DSL transceiver module 125 of the auxiliary LTU 112-12 is given to the bridge forwarder 118 as it is, a physical interface number set in the bridge forwarder 118 should be rewritten upon every occurrence of failure. In the foregoing example, setting is required to rewrite the physical interface number from “1/1” to “12/1”. Further, when setting configuration or monitoring the state of the subscriber line accommodation device 103 thereafter, necessity arises for using the line number in the auxiliary LTU 112-12 after the switching with respect to the circuit portion subjected to the failure, so that the processing becomes complicated. Further, with respect to the function where setting is implemented based on interfaces of the bridge or the service where it is necessary to hold the state of service based thereon, necessity arises, upon switching of the interface, for reading the information as corresponding to an interface after the switching or temporarily stopping the service. This results in causing suspension of the service longer than a physical line switching time caused by an end user. To give an example, the address allocation by the DHCP server 171B is managed per interface. In the case where the DHCP server 171B has a function of judging it to be illegal access when an interface does not agree and performing blocking, necessity arises for changing a database (not illustrated) of the server or a security check function thereof in consideration of the interface switching.

In view of this, in the subscriber unit redundant system of this embodiment, it is configured that setting about configuration using a user interface by an operator can be implemented using a physical interface before occurrence of the failure, ignoring the presence of the auxiliary LTU 112-12, with respect to setting of the first to 11th LTUs 112-1 to 112-11. Specifically, in this embodiment, there is provided a mapping table as a conversion table for converting a physical interface to a logical interface. Using this mapping table, conversion of a corresponding identifier can be automatically implemented.

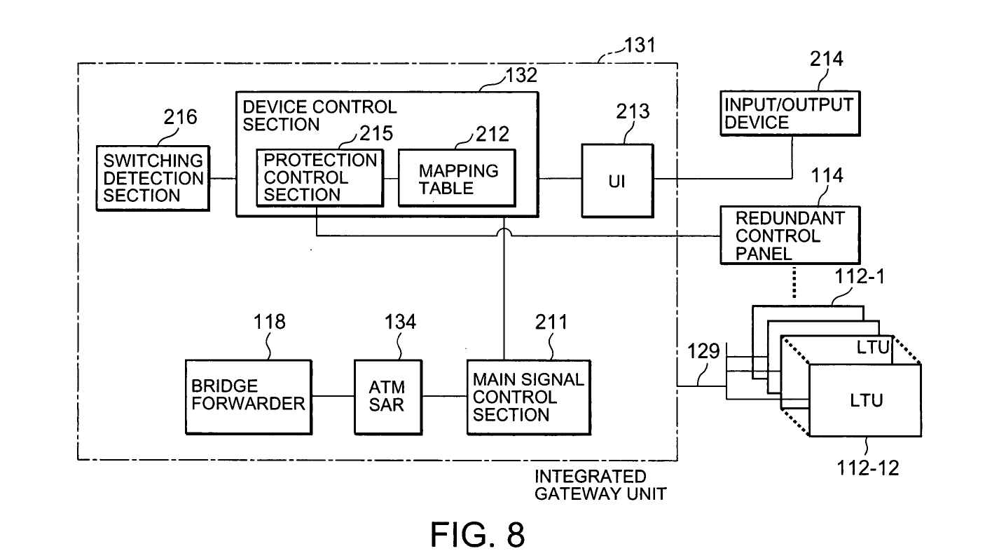

FIG. 8 is a principle diagram showing a circuit for performing interface conversion and its peripheral configuration. Between the ATM SAR 134 and the backplane bus 129 in the integrated gateway unit 131, there is provided a main signal control section 211 formed by an ASIC. The main signal control section 211 refers to a mapping table 212 formed in a memory area within the device control section 132 to thereby perform conversion of a physical interface number to a logical interface number. The device control section 132 is connected to an input/output device 214 comprising nonillustrated keyboard, display, and the like, via a user interface (UI) 213. When failure is detected in any of the first to 11th LTUs 112-1 to 112-11 by an error monitor mechanism (not illustrated) or when a command for switching is input from the input/output device 214 by an operator, a switching detection section 216 connected to the device control section 132 detects that switching to the auxiliary LTU 112-12 is implemented with respect to a subject circuit portion. Based on this, the main signal control section 211 notifies a physical interface number of the subject circuit portion to the redundant control panel 114. In the device control section 132, a protection control section 215 is provided as a section for executing a redundant control.

In FIG. 8, the device control section 132 serves as an identification information assigning section and an upon-failure identification information changing section both of which are claimed in claim 2. The mapping table 212 serves as a correlation table claimed in claim 2. The main signal control section 211 serves as a packet processing section claimed in claim 1. The user interface 213 serves as an upon-failure switching display section claimed in claim 4.

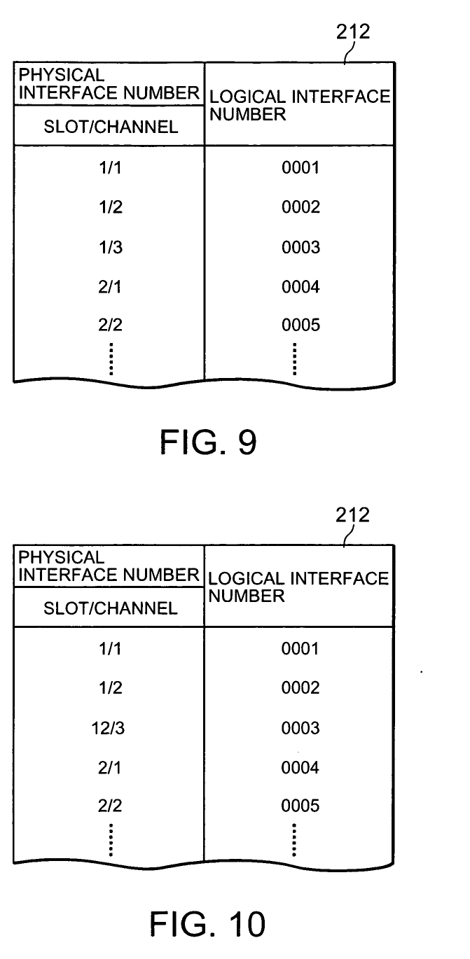

FIG. 9 shows part of the mapping table 212. In the mapping table 212, physical interface numbers each composed of a slot number and a channel number, and logical interface numbers are stored being associated with each other. The mapping table 212 is prepared by the protection control section 215 which, when any of the DSL subscriber lines 102-1 to 102-M shown in FIG. 3 links up, allocates a unique logical interface number to a physical interface number representing the subject physical line.

When packets are sent from the ADSL modems 101 via the DSL subscriber lines 102-1 to 102-M, the first to 11th LTUs 112-1 to 112-11 assign identifiers of physical interfaces to the packets and send them to the backplane bus 129. In response to reception of these packets via the backplane bus 129, the main signal control section 211 refers to the mapping table 212 to thereby obtain logical interface numbers corresponding to the respective physical interface numbers. The main signal control section 211 rewrites the physical interface numbers on the packets into the obtained logical interface numbers. Then, the main signal control section 211 feeds these packets to the bridge forwarder 118 via the ATM SAR 134. Consequently, for example, the packet received from a physical interface number “1/3” is recognized as the packet of a logical interface number “0003” by the bridge forwarder 118.

On the other hand, a packet received from the bridge forwarder 118 by the main signal control section 211 is assigned a logical interface number of an output destination by the bridge forwarder 118. The main signal control section 211 searches the mapping table 212 using this logical interface number as a key. The main signal control section 211 converts the logical interface number to a corresponding physical interface number. Based on this physical interface number, the packet is delivered to the corresponding LTU in the first to 11th LTUs 112-1 to 112-11. For example, the packet of the logical interface number “0003” is converted to the packet of the physical interface number “1/3” and sent to the backplane bus 129.

The foregoing description relates to the conversion of the interface number when no failure occurs in the first to 11th LTUs 112-1 to 112-11. It is assumed, as an example, that failure has occurred in the DSL transceiver module 125-3 (not illustrated) corresponding to the line of a physical interface number “1/3” in the first LTU 112-1 mounted in the first slot and the switching detection section 215 has detected a switching commend. Based on this, the protection control section 215 notifies the physical interface number “1/3” of the failure portion to the redundant control panel 114.

Based on this notification, the redundant control panel 114 implements a control of switching to the third channel of the auxiliary LTU 112-12 mounted in the twelfth slot. Specifically, the relay excitation control circuit 124 shown in FIG. 4 controls the first relay contact selection circuit 122-1 of the first splitter unit 104-1 to switch a contact of the corresponding third change-over switch 121-J (not illustrated) to its normally-open contact side. As a result, a packet that should be input into the DSL transceiver module 125-3 corresponding to the line of the physical interface number “1/3” is input into the DSL transceiver module 125-355 (not illustrated) corresponding to the third channel of the auxiliary LTU 112-12, bypassing the DSL transceiver module 125-3.

Simultaneously, setting information prescribing ADSL connection properties, which is set in the DSL transceiver module 125-3 corresponding to the physical interface number “1/3”, is copied into the DSL transceiver module 125-355. As such setting information, there can be cited ranges of maximum connection speed and minimum connection speed, noise margin, error recovery power, and so on. These information are used in training of DSL transceivers depending on communication environment such as distances from individual subscribers' homes to the subscriber line accommodation device 103 (FIG. 3) along the DSL subscriber lines 102-1 to 102-M. Note that “training” is an operation wherein ADSL modems (transceivers) disposed at both ends of an ADSL line judge the state of the line and negotiate optimal communication parameters, which is based on the same principle as that of the technique used for analog modems and facsimile devices. Therefore, the condition set in the DSL transceiver module 125-3 before the switching needs to be reflected in the DSL transceiver module 125-355 after the switching.

Upon completion of the switching to the auxiliary LTU 112-12 as described above, the protection control section 215 stores in the foregoing memory area within the device control section 132 the fact that the physical interface number “1/3” has been switched to the physical interface number “12/3”, i.e. the fact that the protection has been implemented. Then, on the basis of this, the protection control section 215 rewrites the mapping table 212.

FIG. 10 corresponds to FIG. 9 and shows a portion of the mapping table 212 that has been rewritten based on the foregoing example. In comparison with the mapping table 212 before the change shown in FIG. 91 the physical interface number “1/3” has been rewritten to the physical interface number “12/3” in the mapping table 212 shown in FIG. 10.

According to the change in the mapping table 212, packets output from the third channel DSL transceiver module 125-355 of the auxiliary LTU 112-12 are delivered to the bridge forwarder 118 as packets of the logical interface number “0003” thereafter. That is, before and after occurrence of the failure, the bridge forwarder 118 receives packets of the same logical interface number “0003” and processes them.

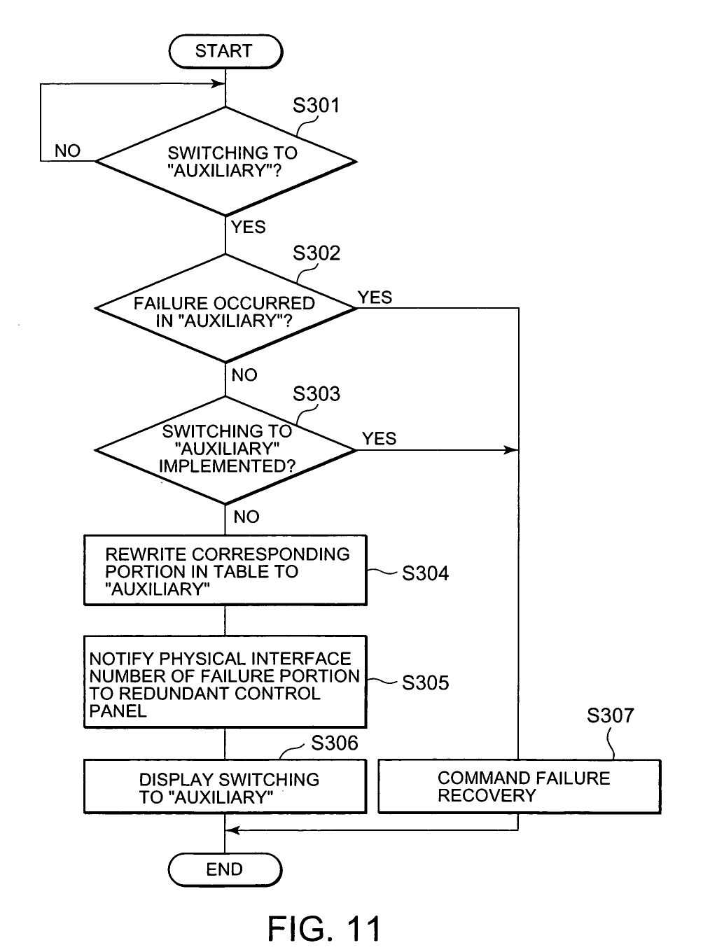

FIG. 11 shows an outline of the flow of processing of the device control section 132 upon occurrence of failure. The device control section 132 implements this processing by the use of a predetermined control program. Specifically, when the device control section 132 is notified from the switching detection section 216 that a circuit portion will be switched to the auxiliary LTU 112-12 due to occurrence of failure (step 5301: Y), the protection control section 215 judges whether or not the failure portion to be subjected to rewriting is the auxiliary LTU 112-12 (step S302). When the failure has occurred in any of the first to 11th LTU 112-1 to 112-11, the processing proceeds to step S303. In step S303, depending on whether or not a physical interface number of the auxiliary LTU 112-12 is written in a pertinent portion of the mapping table 212, it is judged whether or not that portion has already been switched to the auxiliary LTU 112-12.

When the judgment in step S303 is negative, i.e. not switched to the auxiliary LTU 112-12, the processing proceeds to step S304 where rewriting of the mapping table 212 is implemented. Specifically, in this case, the failure has occurred in any of the first to 11th LTU 112-12, and further, the auxiliary LTU 112-12 can cope with the failure. Therefore, an identifier of a physical interface concerned in the mapping table 212 is rewritten to an identifier of a corresponding channel of the auxiliary LTU 112-12. On the basis of this, the protection control section 215 notifies the physical interface number of the failure portion to the redundant control panel 14, thereby switching the subject circuit portion to the auxiliary LTU 112-12 (step S305). Then, the protection control section 215 controls the input/output device 214 via the user interface 213 to display the occurrence of the failure and the recovery by the switching to the auxiliary LTU 112-12 (step S306).

On the other hand, when step S302 judges that the failure has occurred in the auxiliary LTU 112-12, it is not possible to recover the failure in the system configuration of this embodiment having only one auxiliary LTU 112-12. Therefore, upon occurrence of such a situation, the protection control section 215 controls the input/output device 214 to perform a display for urgent failure recovery, thereby commanding the failure recovery (step S307). It may be configured that a notification to that effect is directly sent to a maintenance company through electronic mail or the like.

Upon occurrence of a rare case where failures occur in the same channel within the first to 11th LTUs 112-1 to 112-11 in a certain time interval, there arises a situation where an identifier of a pertinent physical interface in the mapping table 212 has already been replaced with that of the auxiliary LTU 112-12. Also in such a case (step S303: Y), the auxiliary LTU 112-12 cannot cope with the failure of the latter occurrence. Accordingly, also in this case, the processing proceeds to step S307 to command quick failure recovery.

In this embodiment as described above, the auxiliary channels are provided in one-to-one correspondence with all the channels in any one of the first to 11th LTUs 112-1 to 112-11. Therefore, even if failures simultaneously occur in a plurality of channels of one LTU 112, simultaneous switching to the auxiliary LTU 112-12 is enabled so that it is possible to enhance the reliability of the subscriber unit redundant system. Further, as the auxiliary LTU 112-12, use can be made of one having the same configuration as that of each of the first to 11th LTUs 112-1 to 112-11. Therefore, it is possible to use the auxiliary LTU 112-12 as a normal LTU 112 upon occurrence of a temporary line increase.

In the embodiment, use is made of the mapping table 212 associating the physical interfaces and the logical interfaces with each other, to thereby virtualize the interfaces handled by the bridge into the logical interfaces. Therefore, it becomes possible to continue the service without changing the setting on the bridge side at all upon occurrence of the redundant switching.

In the embodiment, one auxiliary DSL subscriber line termination unit is allocated to 11 DSL subscriber line termination units. However, naturally, the numbers thereof can be optionally changed. Further, in the embodiment, one auxiliary DSL subscriber line termination unit is provided for one system. However, two or more auxiliary DSL subscriber line termination units can be provided for one system. In this case, it may be configured that a priority order is provided for switching them and identifiers of physical interfaces are managed using the mapping table 212 in the same manner. Further, in the embodiment, the mapping table 212 is provided in the memory of the device control section 132, but may be provided in the main signal control section 211 for speeding up the processing.

As described above, according to this invention, the current-use subscriber unit and the auxiliary subscriber unit can have the physically identical configuration so that the production cost can be reduced. Further, when the redundant configuration for coping with occurrence of failure is not required, the number of subscriber lines that can be handled in the whole system can be increased by adding the auxiliary subscriber unit to the current-use subscriber units. Therefore, even when an increase in number of subscriber lines does not temporarily correspond to expansion of the device, it is possible to cope with the increase in number of subscriber lines.

1. A subscriber unit redundant system comprising:
a predetermined number of current-use subscriber units each provided on a board with processing circuits of the same structure for a plurality of channels and each corresponding to as many subscriber lines as the number of said plurality of channels;
an auxiliary subscriber unit provided on a board with processing circuits for said plurality of channels, said processing circuits each having the same structure as the processing circuit of said current-use subscriber unit; and
a per-channel switching circuit that, upon occurrence of failure in any of the processing circuits in said predetermined number of current-use subscriber units, switches a path connecting between the subscriber line and the processing circuit which both correspond to the channel subjected to the occurrence of the failure, to a path connected to the processing circuit of the same channel in said auxiliary subscriber unit.

2. A subscriber unit redundant system according to claim 1, further comprising:
an identification information assigning section for assigning mutually different logical identification informations to respective physical identification informations of the subscriber lines connected to said predetermined number of current-use subscriber units;
an upon-failure identification information changing section for, upon the occurrence of the failure in any of the processing circuits in said predetermined number of current-use subscriber units, allocating the logical identification information corresponding to the physical identification information of the subscriber line corresponding to the channel subjected to the occurrence of the failure, as logical identification information corresponding to physical identification information of the same channel of said auxiliary subscriber unit;
a correlation table reflecting a correlation, assigned by said identification information assigning section, between the physical identification informations and the logical identification informations and a correlation, changed by said upon-failure identification information changing section, between the physical identification information and the logical identification information; and
a packet processing section for processing packets input into and output from the respective subscriber lines, according to the logical identification informations by referring to said correlation table.

3. A subscriber unit redundant system according to claim 1, wherein each of said current-use subscriber units and said auxiliary subscriber unit is a DSL subscriber line termination unit and each of said processing circuits is a DSL transceiver module.

4. A subscriber unit redundant system according to claim 1, further comprising an upon-failure switching display section for, upon the switching, by said per-channel switching circuit, of the processing circuit of the channel subjected to the occurrence of the failure to the processing circuit of the same channel in said auxiliary subscriber unit, displaying it to the exterior.

5. A subscriber unit redundant system according to claim 1, wherein said per-channel switching circuit comprises:
change-over switches disposed corresponding to said current-use subscriber units for switching, per channel, between connection to the processing circuit of said current-use subscriber unit and connection to the processing Circuit of the same channel in said auxiliary subscriber unit; and
a switching control section for causing one of said change-over switches corresponding to the processing circuit subjected to the occurrence of the failure to switch from the current-use subscriber unit to the auxiliary subscriber unit,

6. A subscriber unit redundant system according to claim 5, wherein said change-over switches of said per-channel switching circuit are disposed in splitter units provided corresponding to said current-use subscriber units, each of said splitter units adapted to split a signal from the subscriber line into a telephone signal of a voice frequency band and an ADSL signal of a predetermined frequency band higher than the voice frequency band.

7. A subscriber unit redundant method comprising the steps of:
providing a predetermined number of current-use subscriber units and an auxiliary subscriber unit, each of said current-use subscriber units and said auxiliary subscriber unit having the same number of processing circuits provided in one-to-one correspondence with a plurality of subscriber lines, said processing circuits serving as per-channel processing circuits; and
upon occurrence of failure in any of the processing circuits in said predetermined number of current-use subscriber units, switching a path connecting between the subscriber line and the processing circuit which both correspond to a channel subjected to the occurrence of the failure, to a path connected to the processing circuit of the same channel in said auxiliary subscriber unit.

8. A subscriber unit redundant method according to claim 7, further comprising:
an identification information assigning step of assigning unique logical identification informations to respective physical identification informations of the subscriber lines connected to said predetermined number of current-use subscriber units;
an upon-failure identification information changing step of, upon the occurrence of the failure in any of the processing circuits in said predetermined number of current-use subscriber units, allocating the logical identification information corresponding to the physical identification information of the subscriber line corresponding to the channel subjected to the occurrence of the failure, as logical identification information corresponding to physical identification information of the same channel of said auxiliary subscriber unit; and
a packet processing step of changing, by said upon-failure identification information changing step, a correlation, assigned by said identification information assigning step, between the physical identification informations and the logical identification informations, and processing packets input into and output from the respective subscriber lines, according to the logical identification informations while using the corresponding processing circuit of said auxiliary subscriber unit upon the occurrence of the failure.
